(19) United States
(12) Patent Application Publication
(10) Pub. No.: US 2011/0235315 A1
(43) Pub. Date: Sep. 29, 2011

(54) Ladder mountable portable work light

(76) Inventor: Nader Nowzari, Richmond Hill (CA)

(21) Appl. No.: 12/659,866

(22) Filed: Mar. 24, 2010

(51) Int. Cl. F21L 4/00; F21S 8/00

(52) U.S. Cl. 362/190; 362/427

(57) ABSTRACT

A ladder mountable work light for illuminating a work area above a ladder, the ladder having a top plate with a top plate opening of predetermined size and shape, and having a base body having a cross section adapted to fit into said top plate opening, spring arms adapted to fit within said top plate opening and hold said base body therein, a socket mounted in said base body for an electric lamp, a power connection mounted in said base body for connecting said socket to a source of electrical power, at least one power outlet mounted in said base body for connection of a power cord, and, a pivot mounting connecting said lamp socket to said base body.

### FIELD OF THE INVENTION

The invention relates to a portable work light mountable on the top plate of a step ladder. The light may be battery powered and may have a mains connector and also incorporate power sockets for plugging in power tools, and a pivot for directing the light in the desired direction.

### BACKGROUND OF THE INVENTION

Working on an upper area, when standing on a step ladder is often hindered by inadequate lighting.

Existing room lighting is usually adapted to throw light downward. This tends to leave the area of work, in the upper area above a step ladder, in partial shadow. In addition, the existing light may be in the wrong place for illuminating the work area, or the workman may actually cast shadows, preventing the existing light from falling on the work area.

Step ladders comprise a ladder frame, and a support frame. The two frames are hinged to a ladder top plate. The ladder top plate is flat, and usually has holes intended to receive hand tools and support them ready to hand for use.

Portable work lights are available. These are usually equipped with simple hooks by which the light can be hung.

In some cases a portable light may be mounted with spring clamps which can be sprung apart and then clamped onto some article in a work area. Work lighting of a more elaborate nature has been proposed in which the lighting is supported on a stand, and may be directed upwardly.

However, these work lights do not satisfy the need for lighting attached to the ladder top plate. Such an ladder mounted work light will preferably by light weight, and incorporate a pivot connection so that the lighting can be directed in various angles, to suit the work in hand.

### BRIEF SUMMARY OF THE INVENTION

With a view to providing at least some of the desirable features described above, the invention comprises a ladder mountable portable work light for illuminating a work area above a ladder, the ladder having a top plate with a top plate opening of predetermined size and shape, and said work light having a base body having a cross section adapted to fit into said top plate opening, spring arms on said base body adapted to fit within said top plate opening and hold said base body therein, a lamp socket for holding a light source, a power connection mounted in said base body for connecting said socket to a source of electrical power, and, a pivot mounting connecting said lamp socket to said base body.

Preferably, the base body will have a collar around its upper end, to lie flat on the ladder top plate.

Preferably the collar will extend out around the base body, and thus support the base body in the top plate opening.

Preferably, the lamp socket will lie flush with the top end of the base body and the collar.

Preferably the lamp socket is mounted on a transverse pivot, and the pivot is sevured within the base body.

Preferably the lamp socket will extend downwardly, and contain said battery integrally therein.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1 is a perspective of a step ladder showing the work light attached to the top plate;

FIG. 2 is a perspective of the work light.

### DESCRIPTION OF A SPECIFIC EMBODIMENT

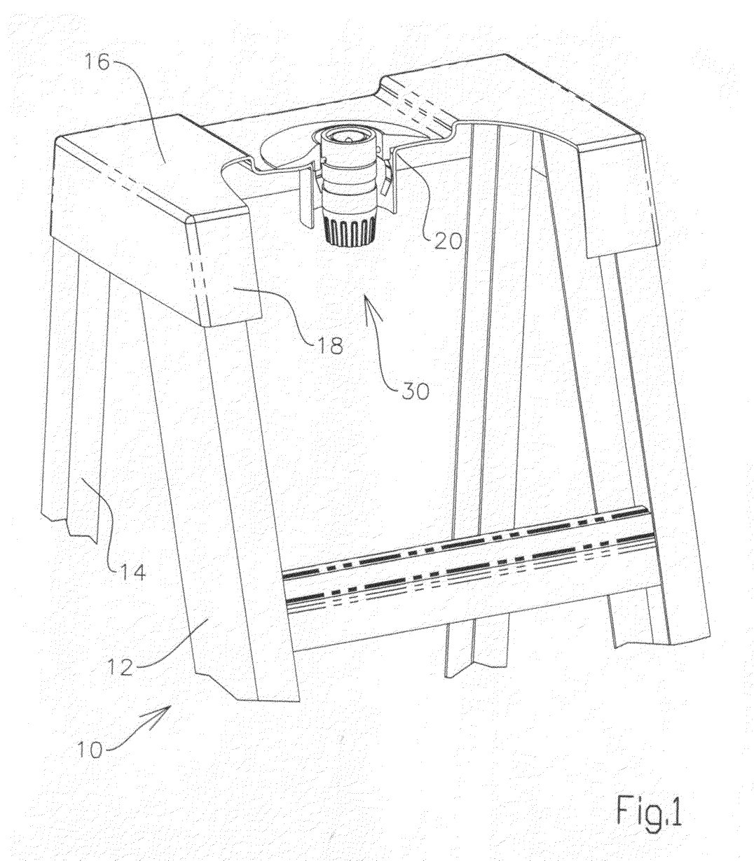

Referring first to FIG. 1 it will be seen that this shows an embodiment of ladder mounted work light, mounted on the top plate or platform of a step ladder, for the purpose of illustrating the invention.

The ladder (10) has the typical step frame (12) and support frame (14). The two frames are hinged to a top plate or platform (16). In this case the top plate (16) is covered by a moulded plastic one piece structure. However many step ladders have top plates made of metal in several parts, and joined eg. by rivets into a homogenous top plate.

The top plate is flat and has side edge flanges (18).

The top plate is formed, in most cases with several holes (not shown), which may vary in size, intended to support hand tools, convenient for use.

A large central opening (20) is usually provided in top plate (16).

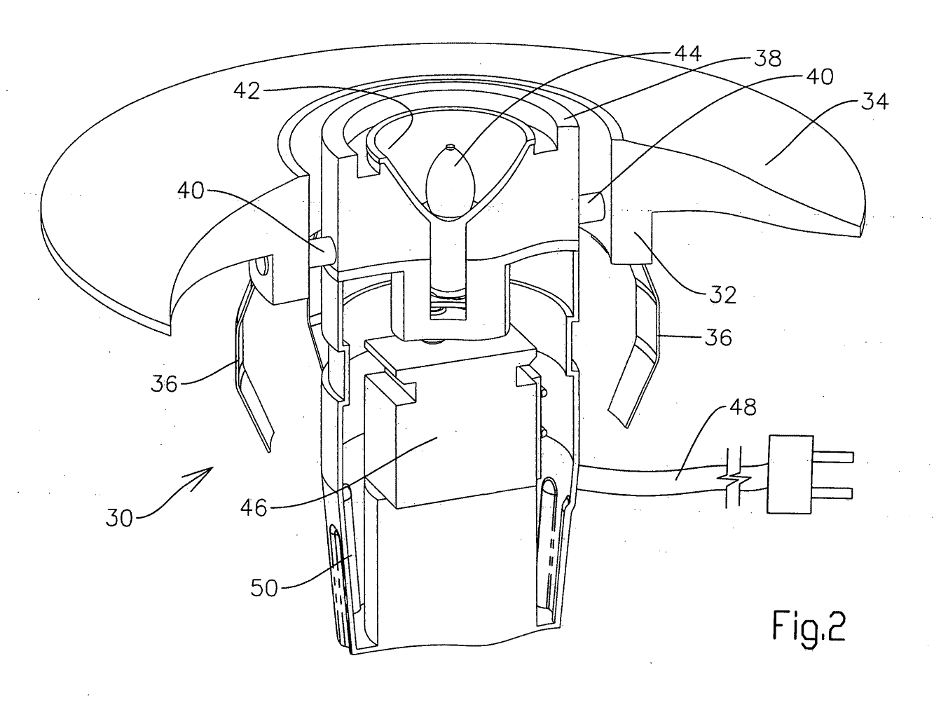

The work light illustrating the invention is shown generally as (30) and in more detail in FIG. 2

It comprises a generally cylindrical base body (32).

A collar (34) extends outwardly from the upper end of base body (32).

A pair of flexible spring arms (36) extend downwardly from base body (32) and are generally convexly curved into outward arcs, extending from opposite sides of base body (32). The spring arms (36) may be squeezed together against the sides of base body (32) manually. They are inherently spring urged, by their own convex shape to spring apart.

In this way the spring arms (36) may be fitted into, eg the large opening (20) in the top plate (16).

The spring arms (36) will then spring apart and clamp the base body (32) to the top plate (16).

The spring arms (36) can be squeezed together slightly, and th entire base body (32) can then be rotated relative to the top plate (16).

A light socket (38) is mounted on a pair of pivot pins (40). Pins are received in opposite sides of base body (32). In this way the lamp socket (38) can be swung on pins (40). Suitable friction means such as washers (not shown) are included to provide a friction effect, thus holding the lamp socket (38) in a desired orientation. A reflector (42) is provided in lamp socket (38), to throw the light from a bulb or bulbs (44) towards a work area. Bulbs may typically be LED bulbs for convenience and long life.

A battery, typically a rechargeable battery (46) is located in lamp socket (38) and is connected to one or more bulbs (44). A switch (not shown) may be provided to switch the bulbs on and off.

Thus the light will shine directly upwardly, or obliquely in a desired upward direction. It will throw illumination upwardly, onto the work area to which the workman is directing attention at the time.

If desired the lamp socket (38) may also be provided with a power cord (48) for connecting to an electrical outlet. One or more power sockets (50) may be provided for connecting power tools (not shown).

The foregoing is a description of a preferred embodiment of the invention which is given here by way of example only. The invention is not to be taken as limited to any of the specific features as described, but comprehends all such variations thereof as come within the scope of the appended claims.

What is claimed is:

1. A ladder mountable portable work light for illuminating a work area above a ladder, the ladder having a top plate with a top plate opening of predetermined size and shape, and said work light comprising;
a base body having a cross section adapted to fit into said top plate opening;
spring arms on said base body adapted to fit within said top plate opening and hold said base body therein;
lamp socket for holding a light source;
a power connection mounted in said base body for connecting said socket to a source of electrical power; and,
a pivot mounting connecting said lamp socket to said base body.

2. A ladder mountable portable work light as claimed in claim 1 including a collar around the upper end of said base body shaped to lie flat on the ladder top plate.

3. A ladder mountable portable work light as claimed in claim 2, wherein said collar extends out around the base body, and thus supports the base body in the top plate opening.

4. A ladder mountable portable work light as claimed in claim 3 wherein said lamp socket lies flush with the top end of the base body and the collar.

5. A ladder mountable portable work light as claimed in claim 4 including a transverse pivot, secured within the base body and said lamp socket being mounted on said pivot.

6. A ladder mountable portable work light as claimed in claim 5 wherein said lamp socket extends downwardly, and contains said battery integrally therein.

7. A ladder mountable portable work light as claimed in claim 6, wherein said base body is circular in plan, and is rotatable within said top plate opening.
